(19) United States
(12) Patent Application Publication
(10) Pub. No.: US 2019/0388952 A1
(43) Pub. Date: Dec. 26, 2019

(54) METHOD FOR PRODUCING A VEHICLE WHEEL CONSISTING OF SHEET METAL

(71) Applicants: ThyssenKrupp Steel Europe AG, Duisburg (DE); thyssenkrupp AG, Essen (DE)

(72) Inventors: David Pieronek, Dortmund (DE); Janko Banik, Altena (DE)

(73) Assignees: ThyssenKrupp Steel Europe AG, Duisburg (DE); thyssenkrupp AG, Essen (DE)

(21) Appl. No.: 16/477,333

(22) PCT Filed: Jan. 18, 2017
(86) PCT No.: PCT/EP2017/050957

§ 371 Date: Aug. 22, 2019

(51) Int. Cl. B21D 35/00; B21D 53/26; B60B 21/10

(52) U.S. Cl. CPC B21D 35/005; B60B 3/041; B60B 21/104; B21D 53/26

(57) ABSTRACT

The present invention relates to a method for producing a vehicle wheel consisting of sheet metal.

### FIELD

The invention relates to a method for producing a vehicle wheel, comprising a rim for receiving a tire and a wheel disk attached to the rim in a substance-to-substance, force-fitting and/or form-fitting manner, with an attachment region for releasably attaching to a wheel carrier, comprising the following steps:

cold forming or cold preforming a rim,

cold forming or cold preforming a wheel disk, and

connecting the wheel disk to the rim in order to form a vehicle wheel.

Furthermore, the invention relates to the use of a vehicle wheel produced by the method according to the invention.

### BACKGROUND

Conventionally produced vehicle wheels, for example motor vehicle wheels, in particular consisting of sheet steel, consist of a rim for receiving a tire and a wheel disk attached to the rim in a substance-to-substance, force-fitting and/or form-fitting manner, with an attachment region for releasably attaching to a wheel carrier. The wheel disk and the rim are conventionally cold formed from a micro-alloyed fine-grained steel or dual phase steel, for example DP600.

A reduction in weight in comparison to the conventionally produced vehicle wheels can be achieved if, firstly, use is made of a material having greater strength or vibration resistance in order to reliably absorb the operating loads, and, secondly, adaptations of the geometry are used in order to compensate for the loss of rigidity on account of smaller material thicknesses. However, the formability of the material generally also decreases with increasing material strength. Thus, the lightweight construction with cold formable steels encounters technical limits. In these cases, use can be made of “hot forming”, by which it is possible to satisfy the requirement for high true strains and at the same time high strengths of the finally formed components.

Currently, materials with lightweight construction potential are hot forming steels, such as, for example, manganese-boron steels, which can absorb mechanical loads, such as dynamic alternating stresses. As prior art, in particular for the production of wheel disks from a hot forming steel, which wheel disks can be press-hardened at least in regions, reference is made to documents DE 10 2007 019 485 A1, DE 10 2013 114 245 B3 and DE 10 2014 108 901 B3. In document DE 10 2007 019 485 A1, the attaching of the hardened individual components (rim/wheel disk) inter alia by welding or soldering is proposed. MAG welding, which is established in vehicle wheel construction, results in melting the basic material and, in the case of hot forming steels, brings about additional annealing effects in the heat influence zone, forming a softening zone (“hardness pocket”). Said softening zone in the region surrounding the welding zone is characterized by low strength and ductility and forms a “metallurgical notch” which can have a detrimental effect on the operating strength of the connection or of the entire component and can lead to premature failure, and therefore the material strength cannot be comprehensively transferred to the entire vehicle wheel.

With regard to the prior art, there is further potential for improvement of vehicle wheels, in particular in respect of using conventional assembly lines, with simultaneously high operating strength and reliability of the vehicle wheels produced, in particular with as low weight as possible and low manufacturing costs.

### SUMMARY

The invention is therefore based on the object of providing a method for producing vehicle wheels, which method can be used as simply as possible in existing assembly lines and can ensure high operating strength and reliability of the (lightweight) vehicle wheels produced, and of indicating a corresponding use of the (lightweight) vehicle wheels produced.

This object is achieved by a method having the features of patent claim 1.

According to the invention, it is provided, according to a first aspect, that a hardenable steel material having a carbon content of at least 0.15% by weight, in particular of at least 0.22% by weight, preferably of at least 0.27% by weight, is provided for the rim and/or wheel disk.

The inventors have established that the provision of hardenable steel materials makes it possible to continue to use conventional assembly lines and, in association therewith, to produce individual components cost-effectively for producing the vehicle wheels since the hardenable steel materials in their delivery state or cold processing state have moderate strengths which are comparable to the hitherto conventionally used steel materials and thus have suitable forming properties which are suitable in particular for cold (pre)forming of the wheel disk and/or of the rim. After the (cold) shaping, the potential of the hardenable steel materials has still not been exhausted. The provided steel material can be a tempering steel, in particular of the type C22, C35, C45, C55, C60, 42CrMo4, a manganese-containing steel, in particular of the type 16MnB5, 16MnCr5, 20MnB5, 22MnB5, 30MnB5, 37MnB4, 37MnB5, 40MnB4, a case-hardening steel, an air-hardening steel or a multi-layered steel material composite, for example having three steel layers, of which at least one of the layers is hardenable.

The wheel disk and the rim are formed or preformed in steps a) and b) by means of compressive forming, tensile forming, tensile-compressive forming, bending forming, shear forming, flow forming, deep drawing or by means of a combination of the production methods mentioned.

The wheel disk is attached to the rim in a substance-to-substance, force-fitting and/or form-fitting manner in step c). Preferably, the wheel disk is attached to the rim at least partially via a joining seam which can be realized as a MIG, MAG, laser, weld or solder seam. Alternatively, the wheel disk can also be attached to the rim by adhesive bonding and/or resistance welding. Alternatively or additionally, a force-fitting attachment by means of an (additional) press fit between the wheel disk and rim is also conceivable, in particular in order to relieve additional connecting means of load. The use of form-fitting, mechanical joining methods, such as, for example, clinching, riveting or with functional elements is likewise possible. The wheel disk and the rim need not necessarily be attached conventionally in what is referred to as the “well base”. Wheel constructions, such as, for example, what are referred to as semi- or full-face disk wheels, or with a multi-part design, are likewise conceivable.

According to a first embodiment, after step c), the vehicle wheel, in a step d), is first of all partially or completely heated to a temperature above the A_{c1} temperature, preferably above the A_{c3} temperature. The A_{c1} temperature corresponds here to the temperature depending on the composition of the steel material at which the structure is converted into austenite, and the A_{c3} temperature corresponds to the temperature at which the conversion into austenite is completely finished. After the heating or soaking, the hot vehicle wheel is then partially hardened in a step e) or completely hardened in a step f). Forming during the hardening is also possible. For the partial or complete hardening, a cooling rate is required which is of a magnitude sufficient to convert the structure, which is initially present substantially in the austenitic state, into a substantially martensitic structure such that partially or completely hardened regions can form. Depending on the composition of the hardenable steel material, corresponding characteristic variables can be gathered from what are referred to as time-temperature diagrams.

After step e), the partially hardened vehicle wheel is annealed in a step i), wherein, by means of the heat treatment, a structure in the partially hardened region having preferably a tensile strength of between 800 and 1200 MPa and/or a hardness of between 250 and 370 HV10 (Vickers hardness test), preferably of between 850 and 1100 MPa and/or a hardness of between 265 and 340 HV10, particularly preferably of between 900 and 1050 MPa and/or a hardness of between 280 and 330 HV10 is sought, as a result of which an optimum operating strength and reliability of the entire vehicle wheel can be ensured.

The inventors have determined by extensive operating strength investigations that the strength range of 800-1200 MPa and/or the hardness range of 250-370 HV10 are particularly suitable for vehicle wheels since, within this range, a good compromise can be established between cyclic reverse bending strength and notch sensitivity, said compromise having an extremely positive effect on the components' performance.

After step f), the completely hardened vehicle wheel is partially annealed in a step g) or is completely annealed in a step h). Depending on the design of the vehicle wheel, the structure of the completely hardened vehicle wheel can be partially or completely heat-treated, wherein preferably a tensile strength in the annealed region of between 800 and 1200 MPa and/or a hardness of between 250 and 370 HV10, preferably of between 850 and 1100 MPa and/or a hardness of between 265 and 340 HV10, particularly preferably of between 900 and 1050 MPa and/or a hardness of between 280 and 330 HV10 is sought in order to be able to ensure optimum operating strength and reliability of the entire vehicle wheel.

According to an alternative embodiment, before step c), the cold formed or cold preformed rim and/or the cold formed or cold preformed wheel disk, in a step j), is first of all partially or completely heated to a temperature above the A_{c1} temperature, preferably above the A_{c3} temperature. After the heating or soaking, the hot rim and/or hot wheel disk is then partially hardened in a step k) or completely hardened in a step l). In the hardened region, there is a substantially martensitic structure. Additional shaping during the hardening is also possible.

According to a first refinement of the first alternative embodiment, after step l), the completely hardened rim and/or the completely hardened wheel disk is partially annealed in a step m) or is completely annealed in a step n). Depending on the embodiment of the vehicle wheel to be produced, the structure of the completely hardened rim and/or wheel disk can be partially or completely heat-treated, wherein preferably a tensile strength in the annealed region of between 800 and 1200 MPa and/or a hardness of between 250 and 370 HV10, preferably of between 850 and 1100 MPa and/or a hardness of between 265 and 340 HV10, particularly preferably of between 900 and 1050 MPa and/or a hardness of between 280 and 330 HV10 is sought.

According to a second refinement of the first alternative embodiment, after step k), the partially hardened rim and/or the partially hardened wheel disk is annealed in a step o), wherein, by means of the heat treatment, a structure in the partially hardened region having preferably a tensile strength of between 800 and 1200 MPa and/or a hardness of between 250 and 370 HV10, preferably of between 850 and 1100 MPa and/or a hardness of between 265 and 340 HV10, particularly preferably of between 900 and 1050 MPa and/or a hardness of between 280 and 330 HV10 is sought.

After the annealing according to step m), n) or o), the wheel disk is connected to the rim in order to form a vehicle wheel, and step c) is carried out.

According to a second alternative embodiment, after the hardening according to step k) (partially hardened rim and/or partially hardened wheel disk) or according to step l) (completely hardened rim and/or the completely hardened wheel disk), the wheel disk is connected to the rim in order to form a vehicle wheel, and step c) is carried out. The vehicle wheel is partially annealed in a step p) or completely annealed in a step q), wherein, depending on the design of the vehicle wheel, preferably a tensile strength in the annealed region of between 800 and 1200 MPa and/or a hardness of between 250 and 370 HV10, preferably of between 850 and 1100 MPa and/or a hardness of between 265 and 340 HV10, particularly preferably of between 900 and 1050 MPa and/or a hardness of between 280 and 330 HV10 is sought, in order to be able to ensure optimum operating strength and reliability of the entire vehicle wheel. In addition, points of weakness, such as, for example, the heat influence zone in the case of substance-to-substance joining connections with introduction of heat (welding, soldering) or critical load regions having a high notch effect, such as, for example, the attachment region to a wheel carrier, in particular the region of the wheel screwing and the region in which ventilation openings/ventilation holes are provided, can be reduced.

According to one refinement, the annealing is carried out at a temperature of at least 200° C., in particular of at least 300° C., preferably of at least 400° C. and below the Ad temperature, preferably below 650° C. The duration of the annealing is dependent on the composition and the material thickness of the corresponding steel material and on the strength to be set of the hardened region. By means of the annealing, in the predominantly martensitic structure, which may be brittle, a high degree of toughness with sufficient strength and ductility can be set, as a result of which a structure state optimum for the cyclic loading of vehicle wheels is produced. Furthermore, by means of the annealing and associated relaxing of the structure, the risk of hydrogen-induced cracking can be reduced. The heat-treated structure corresponds to a substantially annealed martensite.

In order to ensure high dimensional accuracy with simultaneously high operating strength and reliability, according to a further refinement a calibration is carried out between the beginning of the annealing process and the restoring of room temperature. The calibration can also take place after the annealing process. During this manufacturing step, the component geometry of the vehicle wheel and/or of the rim and/or of the wheel disk is calibrated via suitable means in order to maintain the corresponding shape accuracy. The calibration can include a slight shaping in order optionally to bring about corrections for the setting of the desired geometry.

According to a further refinement, the hardening is carried out only in the edge layer of the hardenable steel material. Through-hardening, in particular across the entire material thickness, is very energy-intensive, for example in the case of sheet metal thicknesses >10 mm which are used for the production of utility vehicle wheels, preferably for the wheel disks of truck wheels. Since, in the case of components predominantly subject to a reverse bending stress, a high hardness is beneficial in particular in the region close to the surface, edge layer hardening is more economical from a manufacturing aspect. In the case of relatively large sheet metal thicknesses, for example >6 mm, in particular >8 mm, particularly preferably >10 mm, preferably essentially only edge layer hardening is carried out.

By means of edge layer hardening, the core material remains unchanged (is tough) and has the effect that additional compressive stresses are introduced at the surface, which stresses can have a positive effect on the fatigue strength of the vehicle wheel.

The second aspect of the invention relates to the use of the vehicle wheel produced by the method according to the invention for cars, utility vehicles, trucks, special-purpose vehicles, buses, omnibuses, whether with an internal combustion engine and/or an electric drive, or towed units or trailers. Depending on the vehicle type, the vehicle wheel with its wheel disk and rim is configured in a manner optimized in terms of load and/or weight with corresponding material thicknesses which can also vary along the respective cross section. The wheel disk is not restricted only to a single-part design, but rather can be formed as a tailored product and/or can be assembled from a multi-part design.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

The invention will be explained in more detail below with reference to drawings, in which, in detail:

FIG. 1 shows a sequence of the method according to a first embodiment of the invention,

FIG. 2 shows a sequence of the method according to a second embodiment of the invention, and

FIG. 3 shows the essential components of a vehicle wheel in a perspective view.

### DESCRIPTION

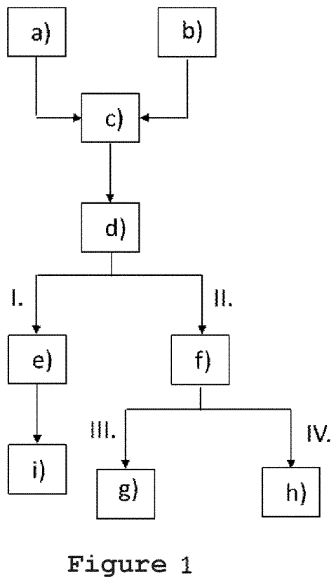

FIG. 1 illustrates a sequence of method steps according to a first embodiment of the invention. For the rim (1) to be produced and/or for the wheel disk (2) to be produced, hardenable steel materials having a carbon content of at least 0.15% by weight, in particular of at least 0.22% by weight, preferably of at least 0.27% by weight are provided. The rim (1) and the wheel disk (2) are cold formed or preformed in steps a) and b) by means of compressive forming, tensile forming, tensile-compressive forming, bending forming, shear forming, flow forming, deep drawing or by means of a combination of the production methods mentioned, in particular also in multiple steps on, for example, transfer or progressive presses. In step c), the wheel disk (2) is attached to the rim (1) in a substance-to-substance, force-fitting and/or form-fitting manner in order to form a vehicle wheel (3). Preferably, the wheel disk (2) is attached to the rim at least partially by a joining seam which can be realized as a MIG, MAG, laser, weld or solder seam. The vehicle wheel (3) after its assembly is heated in a step d) first of all partially or completely to a temperature above the A_{c1} temperature, preferably above the A_{c3} temperature.

According to a first alternative, after the heating or soaking, the hot vehicle wheel (3) can be partially hardened in a step e), following the arrow I. After step e), the partially hardened vehicle wheel (3) is annealed in a step i), wherein, by means of the heat treatment, a structure in the partially hardened region having preferably a tensile strength of between 800 and 1200 MPa and/or a hardness of between 250 and 370 HV10, preferably of between 850 and 1100 MPa and/or a hardness of between 265 and 340 HV10, particularly preferably of between 900 and 1050 MPa and/or a hardness of between 280 and 330 HV10 is sought, as a result of which optimum operating strength and reliability of the entire vehicle wheel (3) can be ensured.

According to a second alternative, after the heating or soaking, the hot vehicle wheel (3) can be completely hardened in a step f), following the arrow II. After step f), the completely hardened vehicle wheel (3) can be partially annealed in a step g), following the arrow III, or can be completely annealed in a step h), following the arrow IV. Depending on the design of the vehicle wheel (3), the structure of the completely hardened vehicle wheel can be partially or completely heat-treated, wherein preferably a tensile strength in the annealed region of between 800 and 1200 MPa and/or a hardness of between 250 and 370 HV10, preferably of between 850 and 1100 MPa and/or a hardness of between 265 and 340 HV10, particularly preferably of between 900 and 1050 MPa and/or a hardness of between 280 and 340 HV10 is sought.

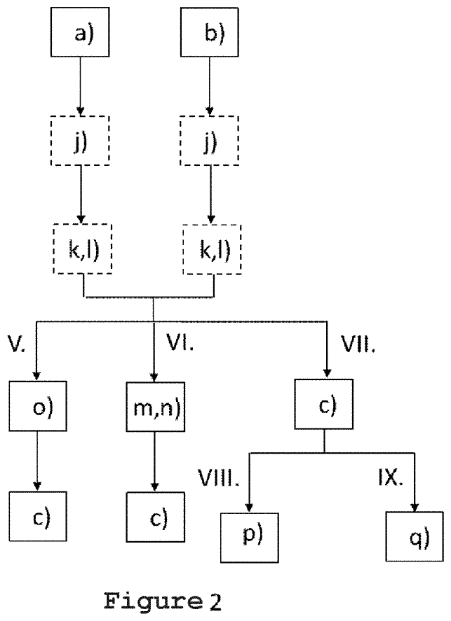

FIG. 2 illustrates a sequence of method steps according to a second embodiment of the invention. For the rim (1) to be produced and/or for the wheel disk (2) to be produced, hardenable steel materials having a carbon content of at least 0.15% by weight, in particular of at least 0.22% by weight, preferably of at least 0.27% by weight are provided. The rim (1) and the wheel disk (2) are cold formed or preformed in steps a) and b) by means of compressive forming, tensile forming, tensile-compressive forming, bending forming, shear forming, flow forming, deep drawing or by means of a combination of the production methods mentioned, in particular also in multiple steps on, for example, transfer or progressive presses. By contrast to the embodiment in FIG. 1, the cold formed or cold preformed rim (1) and/or the cold formed or cold preformed wheel disk (2), in a step j), is first of all partially or completely heated to a temperature above the A_{c1} temperature, preferably above the A_{c3} temperature. Depending on requirements, step j) can be carried out either only on the cold formed or cold preformed rim (1) or only on the cold formed or cold preformed wheel disk (2) or on both components (1, 2), and is therefore illustrated by dashed lines. For example, only the wheel disk (2) composed of a hardenable steel material, for example of the type C45 or 42CrMo4, is heated, whereas the rim (1) can be composed of a conventional steel material and is not heated. After the heating or soaking, the hot rim (1) and/or the hot wheel disk (2) is subsequently partially hardened in a step k) or completely hardened in a step l).

After step k), following the arrow V, the partially hardened rim (1) and/or the partially hardened wheel disk (2) is annealed in a step o), wherein, by means of the heat treatment, a structure in the partially hardened region having preferably a tensile strength of between 800 and 1200 MPa and/or a hardness of between 250 and 370 HV10, preferably of between 850 and 1100 MPa and/or a hardness of between 265 and 340 HV10, particularly preferably of between 900 and 1050 MPa and/or a hardness of between 280 and 330 HV10 is sought. The rim (1) and the wheel disk (2) are subsequently connected to each other in order to form a vehicle wheel (3), and step c) is carried out.

After step l), following arrow VI, the completely hardened rim (1) and/or the completely hardened wheel disk (2) is partially annealed in a step m) or completely annealed in a step n). Depending on the design of the vehicle wheel (3) to be produced, the structure of the completely hardened rim (1) and/or wheel disk (2) can be partially or completely heat-treated, wherein preferably a tensile strength in the annealed region of between 800 and 1200 MPa and/or a hardness of between 250 and 370 HV10, preferably of between 850 and 1100 MPa and/or a hardness of between 265 and 340 HV10, particularly preferably of between 900 and 1050 MPa and/or a hardness of between 280 and 330 HV10 is sought. The rim (1) and the wheel disk (2) are subsequently connected to each other in order to form a vehicle wheel (3), step c).

Following the arrow VII, after the hardening according to step k) (the partially hardened rim (1) and/or the partially hardened wheel disk (2)) or according to step l) (the completely hardened rim (1) and/or the completely hardened wheel disk (2)), the rim (1) and the wheel disk (2) are connected to each other in order to form a vehicle wheel (3), step c). The vehicle wheel (3) is partially annealed in a step p), following arrow VIII, or is completely annealed in a step q), following the arrow IX, wherein, depending on the design of the vehicle wheel, preferably a tensile strength in the annealed region of between 800 and 1200 MPa and/or a hardness of between 250 and 370 HV10, preferably of between 850 and 1100 MPa and/or a hardness of between 265 and 340 HV10, particularly preferably of between 900 and 1050 MPa and/or a hardness of between 280 and 330 HV10 is sought, in order to be able to ensure optimum operating strength and reliability of the entire vehicle wheel.

If the vehicle wheel is not intended to be completely hardened and annealed, preferably only the wheel disk is composed of a hardenable steel material, preferably of the types C22, C35, C45, C55, C60, 42CrMo4, 16MnB5, 16MnCr5, 20MnB5, 22MnB5, 30MnB5, 37MnB4, 37MnB5, 40MnB4, or a multi-layered steel material composite, and conventional steel materials, such as, for example, S355, S420MC, S460MC, are used for the rim.

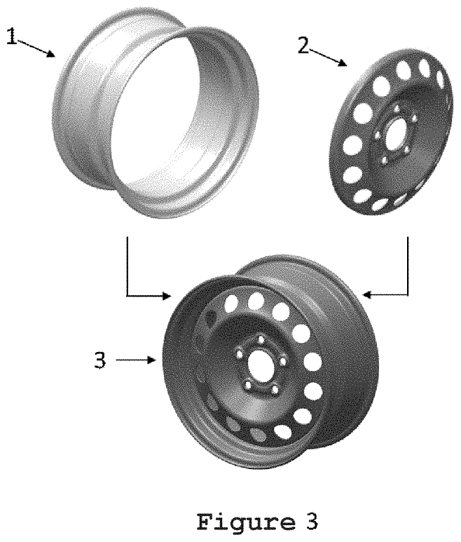

FIG. 3 shows, in a perspective view, a rim (1), a wheel disk (2) and a vehicle wheel (3) which is composed or formed from a rim (1) and a wheel disk (2) attached to the rim (1) in a substance-to-substance, force-fitting and/or form-fitting manner.

1. A method for producing a vehicle wheel consisting of sheet metal, comprising a rim for receiving a tire and a wheel disk attached to the rim in a substance-to-substance, force-fitting and/or form-fitting manner, with an attachment region for releasably attaching to a wheel carrier, comprising the following steps:
a) one of cold forming and cold preforming a rim,
b) one of cold forming and cold preforming a wheel disk, and
c) connecting the wheel disk to the rim in order to form a vehicle wheel,
wherein at least one of the rim and the wheel disk comprises a hardenable steel material having a carbon content of at least 0.15% by weight.

2. The method as claimed in claim 1,
wherein after step c), the vehicle wheel, in a step d), is first of all partially or completely heated to a temperature above the A_{c1} temperature, preferably above the A_{c3} temperature, and then the hot vehicle wheel is one of partially hardened in a step e) and completely hardened in a step f).

3. The method as claimed in claim 2,
wherein after step f), the completely hardened vehicle wheel is one of partially annealed in a step g) and completely annealed in a step h).

4. The method as claimed in claim 2,
wherein after step e), the partially hardened vehicle wheel is annealed in a step i).

5. The method as claimed in claim 1,
wherein before step c), the cold formed or cold preformed rim and/or the cold formed or cold preformed wheel disk, in a step j), is first of all completely heated to a temperature above the A_{c1} temperature, preferably above the A_{c3} temperature, and then at least one of the hot rim and the hot wheel disk is one of partially hardened in a step k) and is completely hardened in a step l).

6. The method as claimed in claim 5,
wherein after step l), one of the completely hardened rim and the completely hardened wheel disk is one of partially annealed in a step m) and is completely annealed in a step n).

7. The method as claimed in claim 5,
wherein after step k), at least one of the partially hardened rim and the partially hardened wheel disk is annealed in a step o).

8. The method as claimed in claim 6,
wherein after step m), n) or o), step c) is carried out.

9. The method as claimed in claim 5,
wherein after step k) or l), step c) is carried out.

10. The method as claimed in claim 9,
wherein the vehicle wheel is one of partially annealed in a step p) and is completely annealed in a step q).

11. The method as claimed in claim 3,
wherein the annealing is carried out at a temperature of at least 200° C. and below 650° C.

12. The method as claimed in claim 11,
wherein between the beginning of the annealing process and restoring of the room temperature or downstream of the annealing process, a calibration are carried out, in particular to ensure the dimensional accuracy.

13. The method as claimed in claim 2,
wherein the hardening is carried out only in the edge layer of the hardenable steel material.

14. The method as claimed in claim 1 wherein
the provided steel material is a tempering steel, in particular of the type C22, C35, C45, C55, C60, 42CrMo4, a manganese-containing steel, in particular of the type 16MnB5, 16MnCr5, 20MnB5, 22MnB5, 30MnB5, 37MnB4, 37MnB5, 40MnB4, a case-hardening steel, an air-hardening steel or a multi-layered steel material composite.

15. The method of claim 1, further comprising using the vehicle wheel for cars, utility vehicles, trucks, special-purpose vehicles, buses, omnibuses, whether with an internal combustion engine and/or an electric drive, or towed units or trailers.

16. The method of claim 1 wherein the hardenable steel material has a carbon content of at least 0.22% by weight.

17. The method of claim 16 wherein the hardenable steel material has a carbon content of at least 0.27% by weight.
